(19) United States
(12) Patent Application Publication
(10) Pub. No.: US 2015/0316207 A1
(43) Pub. Date: Nov. 5, 2015

(54) Composite Pressure Vessel Integrated Mandrel

(71) Applicant: Infinite Composites, LLC, Broken Arrow, OK (US)

(72) Inventor: Aaron E. Laney, Broken Arrow, OK (US)

(73) Assignee: Infinite Composites, LLC

(21) Appl. No.: 14/703,378

(22) Filed: May 4, 2015

Related U.S. Application Data
(60) Provisional application No. 61/988,088, filed on May 2, 2014.

(51) Int. Cl. F17C 1/00; B05D 1/02; C09J 5/00

(52) U.S. Cl. CPC F17C 1/00; C09J 5/00; B05D 1/02; C09J 2433/00

(57) ABSTRACT

A composite pressure vessel and method of manufacture. A composite pressure vessel comprises a multi-component mandrel that is integrated into the vessel, thereby becoming a permanent part of the pressure vessel, and comprises a cylinder and dome ends. Dome ends are made from custom molds with a fiber reinforced polymer. Components of the mandrel may be pieced together with a joining resin. The mandrel comprises a permeation barrier coated on the inside by spraying with elastomer resin, for example. Filaments are wound onto the mandrel, allowing any length of cylinder section to be made for the pressure vessel.

### CROSS REFERENCE TO RELATED APPLICATIONS

This application claims priority to provisional patent application Ser. No. 61/988,088 which is entitled COMPOSITE PRESSURE VESSEL INTEGRATED MANDREL, filed May 2, 2014, the entirety of which is incorporated herein by reference. The period of pendency of the foregoing provisional application Ser. No. 61/988,088 is extended to May 4, 2015 since the date for taking action to file a utility application under 35 U.S.C. §111(a) claiming priority to the provisional application falls on a Saturday.

### TECHNICAL FIELD OF THE INVENTION

The present invention relates generally to pressure vessels and methods of manufacture and more particularly, to Type W composite pressure vessels. A method of manufacturing a composite pressure vessel with a composite, integrated mandrel also is provided.

### SUMMARY OF THE INVENTION

The present invention is directed to a composite pressure vessel comprising a mandrel, the mandrel comprising a body and at least two ends, wherein the mandrel forms an integral part of the pressure vessel, and an internal permeation barrier.

The present invention further is directed to a mandrel for a composite pressure vessel, the mandrel comprising a center portion and at least two end portions, wherein the mandrel forms an integral part of the pressure vessel.

The present invention further is directed to a method of making a composite pressure vessel, the method comprising the steps of forming an integrated mandrel from multiple components, creating a permeation barrier inside the mandrel, and including the integrated mandrel as part of the pressure vessel.

The foregoing and other objects, features, and advantages of the invention will appear more fully hereinafter from a consideration of the detailed description that follows.

### BRIEF DESCRIPTION OF THE DRAWINGS

FIG. 1 illustrates an exploded and partial cutaway view of an exemplary pressure vessel comprising an integrated mandrel of the present invention.

FIG. 2 illustrates a cross-sectional view of the exemplary pressure vessel comprising an integrated mandrel of the present invention taken along line 2-2 of FIG. 1.

FIG. 3 illustrates a perspective view of an exemplary dome-shaped end of the integrated mandrel of the present invention.

FIG. 4 illustrates a cross-sectional view of a threaded first end of the exemplary pressure vessel comprising a composite mandrel of the present invention taken along line 4-4 of FIG. 1.

FIG. 5A illustrates a perspective view of a flange useful as a fitting in the present invention.

FIG. 5B illustrates a perspective view of a boss front useful as a fitting in the present invention.

FIG. 5C illustrates a perspective view of a boss back useful as a fitting in the present invention.

FIG. 5D illustrates a perspective view of a nut useful in the fitting of the present invention.

FIG. 6 illustrates an end view of an exemplary pressure vessel comprising an integrated mandrel of the present invention.

FIG. 7 illustrates a side view of the unitary integrated mandrel of the present invention.

### DETAILED DESCRIPTION OF THE INVENTION

Pressure vessels are in demand as the use of alternate fuels, particularly compressed natural gas, becomes more desirable and more economical, especially in developing regions of the world. The industry categorizes pressure vessels into five general types: (I) all steel or metal vessels, (II) all metal vessels with a partial fiber overwrap, (III) a metal liner with a full fiber composite overwrap, (IV) vessels of all composite construction and comprising a polymer liner and (V) linerless vessels comprising filament wound composite materials. Type I vessels are the least expensive but are much heavier than the other types, which detracts from their serviceability. Type II vessels weigh significantly less than type I but cost appreciably more. Types III and IV carry even greater weight savings and serviceability but are accompanied by a higher price tag. Type V linerless vessels are viewed as the most desirable as inherently lightweight due to the lack of an inner liner. However, linerless vessels do not yet provide the desired performance characteristics of Types I through IV and have not yet been proven to operate at high pressures.

Pressure vessels must meet a number of performance requirements which necessitate, depending upon the ultimate use to which the vessel is put, tensile strength, structural rigidity, high pressure tolerance, thermal insulation, corrosion resistance and compatibility with stored chemicals, all while maintaining low weight. Conventional manufacturing techniques designed to meet these needs involve overwrapping a vessel with a composite. In the pressure vessel industry, a composite is a combination of structural fibers, in some form, such as continuous or chopped glass, carbon or polymer fibers, which may be coated with or contained within a matrix, such as a polymer, resin or plastic. The fibers may be used to overwrap the vessel. Composite fibers provide structural integrity while the resin, polymer or plastic coating or matrix maintains the fiber position.

Composite pressure vessels have traditionally been made by creating a liner either by extruding and hammer forging an aluminum tank or blow molding a plastic liner then overwrapping it with a fiber reinforced epoxy. The composite generally is not considered to be pressure tight, thus it is applied over a fluid retention barrier that serves as an interior liner for the vessel. As used herein, the fluid retention barrier may also be called a “permeation barrier”. The permeation barrier may be an elastomeric, plastic, or metal liner. The permeation barrier helps maintain acceptable leak rates and protects against contamination of the interior fluid but adds little structural integrity to the pressure vessel.

While composite overwrapped pressure vessels (“COPV”) can meet certain industry requirements for smaller applications, they have more limited use for larger vessels, which are typically larger than about two feet in diameter and at least six feet in length. Large COPV, which are manufactured using high density polyethylene (HDPE) liners, typically are manufactured in sections that are later sealed together to create an integral unit, which presents inherent weaknesses in structural failure and opportunity for leaks. Consequently, these COPV present limitations that are difficult to overcome. For example, large COPV are generally multi-component pieces that are joined using heat. These liners are very thick and heavy and have problems bonding to the structural overwrap.

The linerless tank utilizes a water soluble mandrel to overwrap a carbon fiber composite and washes the mandrel out after curing. This method works well for smaller vessels but, again, presents inherent difficulties for large vessels. In particular, excessive weight causes problems with cracked mandrels, and considerable man hours are required to produce a washable mandrel by hand.

There is a need in the industry for a large, lightweight pressure vessel without a metal liner, yet which possesses the desired characteristics of structural rigidity, strength and other performance criteria. The present invention provides a new all-reinforced composite pressure vessel comprising an integrated mandrel and a manufacturing process therefor which is useful for large composite pressure vessels. As described in more detail herein, the invention entails a new type of fiber placement and hot press resin injection or hand layup of cloth or mat for ends of the mandrel and filament winding for the body of the mandrel.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

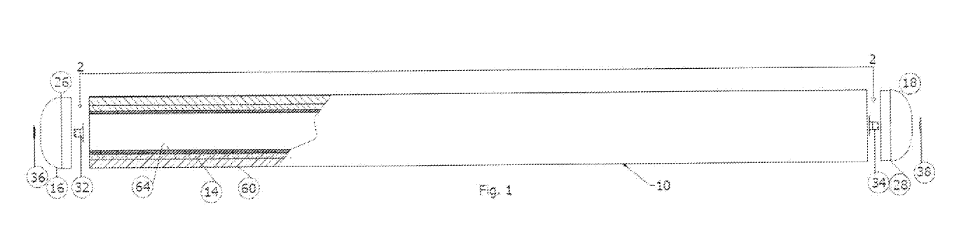

Turning now to the drawings in general and to FIGS. 1 and 2 in particular, there is shown therein an embodiment of a composite pressure vessel 10 with integrated mandrel 12 of the present invention. The mandrel 12 defines the size and shape of the pressure vessel 10. The mandrel 12 may be any shape, including cylindrical, spherical, cubed, cuboid, conical, pyramidal, prismatic, or any other three-dimensional shape suitable to the application for which the pressure vessel 10 is intended. In one embodiment of the invention, the mandrel 12 is cylindrical. In another embodiment of the invention, the mandrel 12 is cuboid.

The mandrel 12 comprises a body 14 and ends 16 and 18. In accordance with the overall shape of the mandrel 12, the body 14 of the mandrel generally corresponds to the shape of the pressure vessel 10. For example, where a cylindrical pressure vessel 12 is desired, the body 14 of the mandrel also will be cylindrical. It will be appreciated, however, that the body 14 of the mandrel 12 may be any shape, including cylindrical, spherical, cubed, cuboid, conical, pyramidal, prismatic, or any other three-dimensional shape suitable to the application for which the pressure vessel is intended. In one embodiment of the invention, the body 14 of mandrel 12 is cylindrical.

The body 14 of mandrel 12 may be constructed by various methods from any materials suitable for use in pressure vessels, such as being machined from metal, including copper, nickel, or aluminum. Alternatively, the material of body 14 of mandrel 12 may comprise nonconductors, such as silicon, carbon, HDPE, polymers, plastics or fiber reinforcements, such as glass, carbon, nylon, polyester, boron, basalt or ceramic, that are contained in a composite matrix, such as epoxy, polyester, or other thermoset resins or thermoplastics.

Further, by way of example, the body 14 of the mandrel 12 may be manufactured from glass or carbon fibers in a resin matrix, using either conventional filament winding on a permanent mandrel or by using a Drostholm process of continuous filament winding of pipe. A continuous filament winding machine (CFW machine/CW machine) is a machine for laying filament windings continuously over a cylindrical steel band. The steel band is carried on a forward moving mandrel which is able to collapse and return to the beginning of the travel. The steel band is released after the mandrel collapses and is continuously fed back to the start of the travel where it is again wound on to the mandrel. The process of Continuous filament winding is also known as the Drostholm Process. In addition to the continuous advancing band, many alternative methods of filament winding also exist. This machine is mainly used to manufacture fiber-reinforced plastic (FRP) pipes and couplings, especially glass-reinforced plastic (GRP) pipes.

It will be appreciated that the body 14 may be produced by other methods and from other materials suited to the particular temperatures, pressures, fluids, and other conditions of the application for which the pressure vessel 10 is designed. In one embodiment of the invention, the body 14 comprises a thin-walled carbon fiber material, which imparts strength and rigidity to the pressure vessel 10 while lessening the overall weight. Carbon is one preferred body 14 material when the pressure vessel 10 will be overwrapped with carbon, in a manner yet to be described. Glass fiber is another preferred body 14 material for the body 14. The thermal expansion coefficients of the body 14 composition material and the overwrap material should at least approximate each other or be as close as possible for the mandrel 12 and the overwrap to prevent delamination.

The diameter and length of the body 14 are variable and depend upon the size of the pressure vessel 12 to be constructed. The length of the body 14 generally ranges from at least about 6 inches to at least about 70 feet, while the diameter of the body generally ranges from at least about 9 inches to at least about 13 feet. The thickness of the body 14 generally ranges from at least about ⅛ inches to at least about ¾ inches. For larger Type IV pressure vessels, the length of the body ranges from at least about 6 feet to at least about 70 feet, while the diameter of the body ranges from at least about 2 feet to at least about 13 feet. The thickness of the body 14 for larger Type W pressure vessels constructed in accordance with the present invention will range from at least about ¼ inch to about ¾ inches. When the body 12 comprises a shape other than cylindrical, the body will comprise a depth and width dimensions which may correspond generally to the ranges provided herein for diameter of the body. References herein to diameters are to outside diameters, unless specifically stated to reference an inner diameter. It will be appreciated, however, that the body 14 may be any diameter and length, or in the case of bodies comprising non-cylindrical shapes, any length width and depth, suited for applications and conditions where the pressure vessel 10 will be used. The body 14 preferably, though not necessarily, complies with American Society of Mechanical Engineers (ASME), ASTM International Standards and/or ISO standards and dimensions. Bodies 14 suitable for use in the invention are produced by NOV Fiber Glass Systems and Flowtite Technology AS, among others.

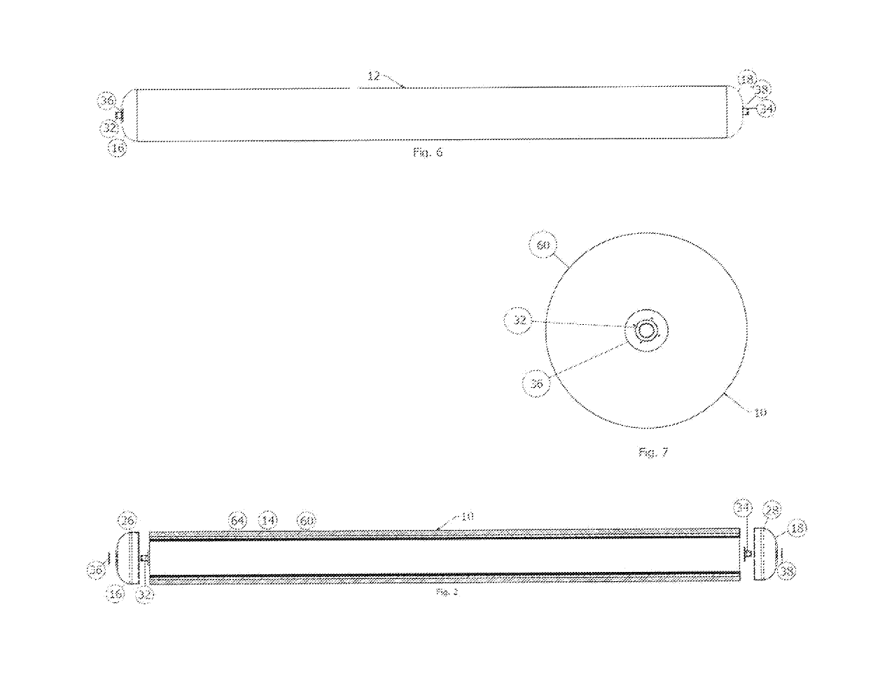

Turning now to FIGS. 3 and 4, and with continuing reference to FIGS. 1 and 2, the mandrel 12 comprises ends 16 and 18 which are secured to the body 14 in a manner yet to be described. The ends 16 and 18 are formed from custom molds tailored to meet shape, performance and application requirements of the body 14, mandrel 12 and pressure vessel 10. For example, in one embodiment of the invention, the ends 16 and 18 are dome-shaped. It will be appreciated, however, that the ends may comprise any shape suited to the conditions, applications and performance requirements. The diameter and thickness of the ends 16 and 18 will correspond generally to the diameter and thickness of the body.

Ends 16 and 18 of mandrel 12 are formed in molds from a fiber reinforced polymer by way of hand layup, spray layup, resin transfer molding (RTM), vacuum bagging (VARTM), injection molding, or hot press molding. The fibers of the fiber reinforced polymer may be in the form of random fibers, chopped fibers, tailored fiber placement, fiber mat or fiber cloth. The fibers may comprise glass, carbon, nylon, polymers, boron, ceramic and mixtures thereof In one embodiment of the invention, carbon or glass fiber tows are attached to a thin poly-cloth base material by stitching the tows in place. The poly-cloth base material can be a 2D-textile, such as a woven or non-woven fabric, or a matrix-compatible foil material for thermoplastic composites. The fibrous material is fixed with an upper and lower stitching thread on a base material. The fiber material can be placed near net-shape in curvilinear patterns upon a base material in order create stress-adapted composite parts. This allows for optimization of fiber angles to reduce the amount of composite needed for the ends 16 and 18. Once the fiber is attached to the poly-cloth, it is placed in the mold, and resin is injection molded into the mold and cured. In one embodiment of the invention, the ends 16 and 18 are comprised of hand layup fiberglass and chopper gun glass and uni-direction reinforced stitched cloth (UDR) or fiberglass cloth weave with vinyl ester or polyester resin, using an open mold.

With continuing reference to FIGS. 3 and 4, the ends 16 and 18 may each comprise a flange 26 and 28, respectively. The outer diameters of the flanges 26 and 28 may be smaller in diameter than the inner diameter of body 14 so that the flanges may fit inside the body for attachment thereto in a manner yet to be described. The flanges 26 and 28, alternatively, may be larger in diameter than the outer diameter of the body 14 to create an overlap joint. The flanges 26 and 28 preferably are made from the same material as ends 16 and 18. The flanges 26 and 28 are formed during the process of forming ends 16 and 18. After fitting flanges 26 and 28 within respective ends the body 14 of mandrel 12, the flanges are secured to the body by application of joining resin, such as methacrylate adhesives, to the joints between the parts.

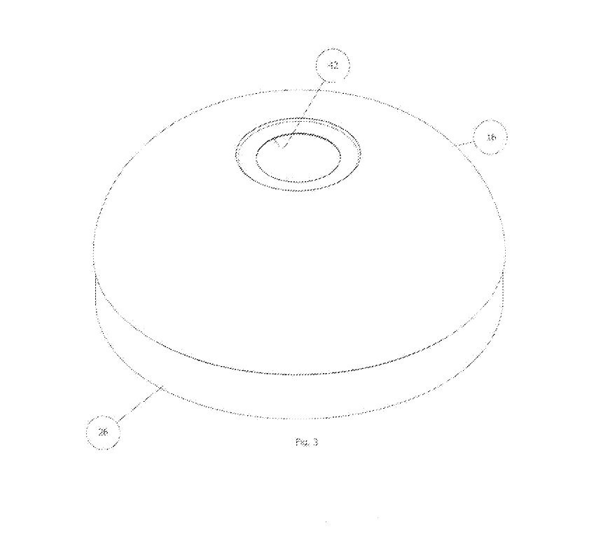

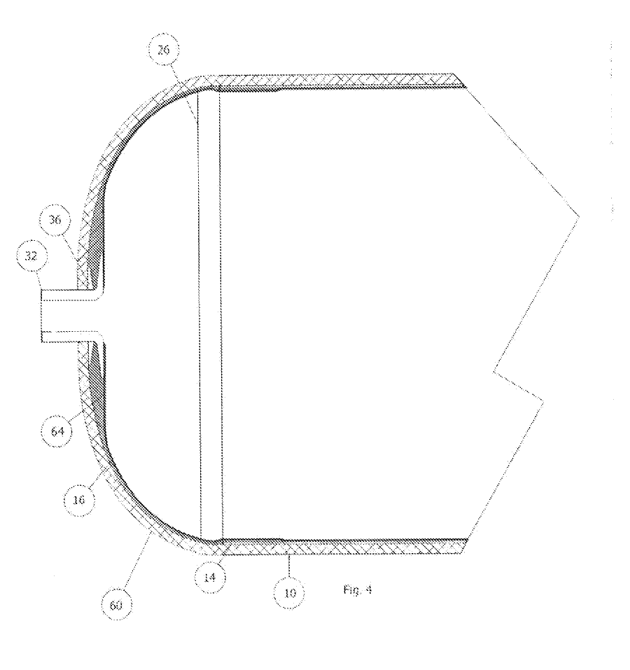

The pressure vessel 10 may further comprise port fittings, which may be any means suitable for filling or emptying the pressure vessel and securing pressure within the vessel. In one embodiment of the invention, threaded fittings 32 and 34 and nuts 36 and 38 are molded into ends 16 and 18 during the process of fabricating the ends. Alternatively, an aperture 42 may be formed in ends 16 and 18, as shown in FIG. 3, and the ends then fitted with external threads, a nut and elastomeric gasket (not shown) affixed in place in the ends. This method of using a gasketed fitting would allow for a modular type of production system that allows the manufacturer to quickly customize a tank by having an inventory of differing sized domes, cylinders, and fittings with different threads. Exemplary fittings useful in the invention include a flange 50, boss front 52 and boss back 54 shown in FIG. 5A, 5B, 5C and 5D, respectively.

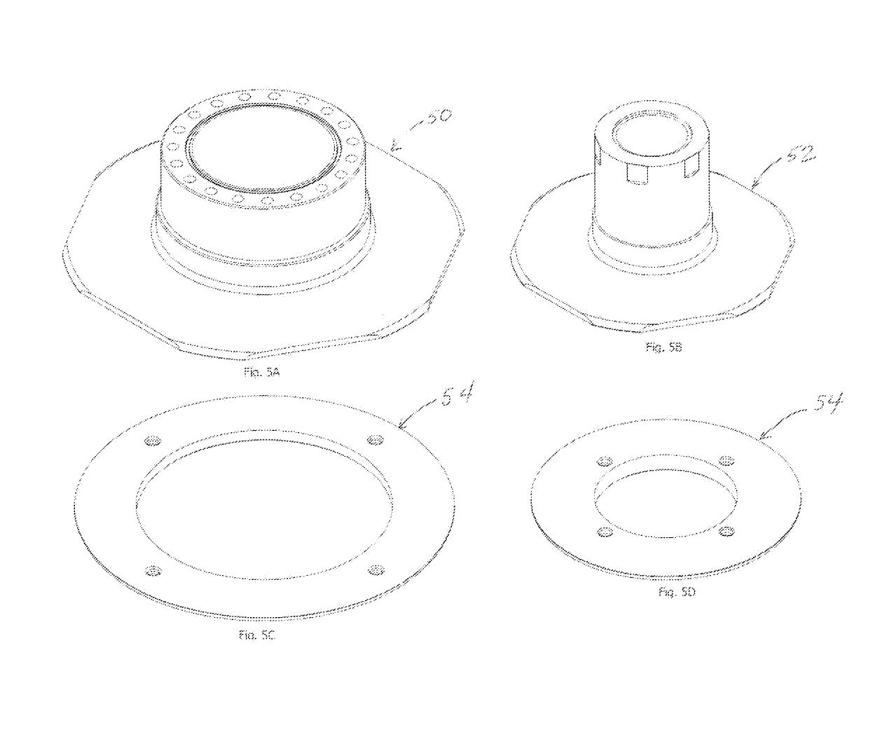

Having created the mandrel 12 by joining ends 16 and 18 with body 12, the mandrel forms a unitary component, as shown in FIG. 6, which forms a permanent part of the pressure vessel and around which the structure of the pressure vessel 10 is formed in a manner now to be described. The mandrel 12 is coated or layered with a substance to create an outer layer 60 of the pressure vessel 10. The outer layer 60 comprises a material that will impart the desired properties and characteristics to the pressure vessel, such as tensile strength, structural rigidity, high pressure tolerance, thermal insulation, corrosion resistance, compatibility with stored chemicals, and low weight. Some materials suitable for the outer layer 60 include composites, resins, polymers, plastics, metals, concrete, silicon, carbon, HDPE, polymers, plastics, and fiber reinforcements, such as glass, carbon, nylon, polyester, boron or ceramic.

The outer layer 60 may be applied by spraying, winding, dipping, wrapping, hand layup, closed mold injection or other means known in art. In one embodiment of the invention, the outer layer 60 is comprised of a filament wound carbon fiber, glass fiber, basalt fiber or a combination thereof which are formed around the mandrel 12 by winding fibers or filaments onto the mandrel by filament winding fabrication techniques. The fibers may be impregnated with a resin at the time of winding through a wet winding process. Alternatively, the fibers may be pre-impregnated with resin and gelled before winding.

The unitary mandrel 12 may be coated on the inside of the body 12 and ends 16 and 18 by spraying the interior with a material to create a permeation barrier 64. The permeation barrier 64 serves several purposes, one of which is to optionally serve as a liner, or seal, in some instances. The permeation barrier 64 also may serve to allow the reinforced mandrel 12 to be strengthened by outer layer 60 and to become part of the structural strength of the pressure vessel 12. Other purposes of the permeation barrier 64 may include corrosion resistance, thermal insulation, and compatibility with stored chemicals, for example. Materials suitable for use as the permeation barrier 64 include elastomers, such as polyurea, polyisoprene or natural rubbers, polybutadiene, polyisobutylene, and polyurethanes. The permeation barrier 64 may be applied to the interior of the mandrel 12 by means known in the art, such as spraying, pumping, brushing and spin coating.

The mandrel 12 may, depending on the certification to be obtained, be included in calculation of strength, because the permeation barrier is inside the mandrel in the form of a sprayed or applied coating. Traditional liners that serve both as permeation barriers and as a mandrel, in some instances, cannot be counted as contributing to the overall strength of the tank. Thus, mandrel 12 of the present invention present the option for D.O.T. or ISO certification as being a load bearing liner, although it will be appreciated that the mandrel does not have to be computed in the overall strength of the pressure vessel 12.

The method of the present invention now will be described in operation. The foregoing description of the invention is incorporated herein by reference. The method of the invention involves forming a mandrel 12 as an integrated and permanent component of a pressure vessel 10. A mandrel body 14 is formed or selected and joined with ends 16 and 18 which are custom made. Ends 16 and 18 may be formed by using a new method of fiber placement which attaches carbon fiber tows to a thin poly-cloth by stitching the tows in place. This allows for optimization of fiber angles to reduce the amount of composite needed for the domes. Once the fiber is attached to the poly-cloth, it is placed in the mold along with a specially prepared metal fittings 36 and 38. Alternatively, an aperture 42 may be formed in ends 16 and 18 and the ends then fitted with external threads, a nut and elastomeric gasket (not shown) affixed in place in the ends. Ends 16 and 18 are joined with body 14 by means such as joining resin, forming a unitary mandrel 12, which forms a permanent part of the pressure vessel and around which the structure of the pressure vessel 10 is formed. The mandrel 12 to be overwrapped with carbon fiber or other material suitable for an outer layer 60.

The mandrel 12 may be coated on the inside by spraying with elastomer resin or other suitable material to create a permeation barrier 64. It will be appreciated that the permeation barrier 64 may be applied either before or after outer layer 60 is applied to mandrel 12. The permeation barrier may also be partially applied inside the body and ends before final assembly of the mandrel.

The efficacy of the present invention is demonstrated by the following experimental test data:

### EXAMPLE

An experimental pressure vessel measuring 47 inches in diameter by 109 inches in length, and with a working pressure of 4500 psi, was fabricated from a composite mandrel made according to the present invention using specifications similar to D.O.T. special permit 14951 and to conform to ISO 11119. The integrated mandrel, including ends constructed in accordance with the present invention, was formed with glass fiber, overwrapped with carbon fiber to create the outer layer and permeation barrier of polyurea was sprayed inside the mandrel. The experimental pressure vessel was proof tested to 6000 psi with a burst of more than 8000 psi.

It now will be appreciated that the present invention provides a composite pressure vessel providing an integrated mandrel having component parts that allows large and oversized vessels to function in high pressure conditions while reducing the overall weight of the vessel and increasing the volume. By using a thin-walled fiber reinforced mandrel, the strength-to-weight ratio is much better over traditional aluminum or HDPE liners. Additionally, the possible lengths of pressure vessels can be extended and the overall weight of the tank greatly reduced. Large Type W pressure vessels of the present invention may be constructed in lengths ranging from at least about 6 feet to at least about 70 feet, while the diameter about of the body ranges from at least about 2 feet to at least about 13 feet. By spraying the inside of the mandrel with a permeation barrier, this allows the fiber reinforced mandrel to become part of the structural strength of the pressure vessel.

The invention of this application has been described above both generically and with regard to specific embodiments. Although the invention has been set forth in what is believed to be preferred embodiments, a wide variety of alternatives known to those of skill in the art can be selected within the generic disclosure. Changes may be made in the combination and arrangement of the various parts, elements, steps and procedures described herein without departing from the spirit and scope of the invention as defined in the following claims.

I claim:

1. A composite pressure vessel, comprising:
A mandrel comprising a body and at least two ends, wherein the mandrel forms an integral part of the pressure vessel; and
an internal permeation barrier.

2. The composite pressure vessel of claim 1 wherein the mandrel is filament wound with a composite material.

3. The composite pressure vessel of claim 1 wherein the body is comprised of a material selected from the group consisting of metals, copper, nickel, aluminum, nonconductors, silicon, carbon, high density polyethylene, polymers, plastics, fiber reinforcements, glass, carbon, nylon, polyester, boron, basalt or ceramic and combinations thereof.

4. The composite pressure vessel of claim 2 wherein the composite material comprises glass, carbon, nylon, polyester, basalt, boron, nylon, ceramic, polymers or combinations thereof.

5. The composite pressure vessel of claim 1 wherein the ends form domes.

6. The composite pressure vessel of claim 5 wherein the ends are comprised of basalt, carbon, or glass fiber or cloth weave with epoxy, vinyl ester or polyester resin.

7. The composite pressure vessel of claim 1 wherein the ends each further comprise a flange to create an overlap joint for securing the ends to the body of the mandrel.

8. The composite pressure vessel of claim 1 wherein the ends form openings that are gasketed with fittings.

9. The composite pressure vessel of claim 1 wherein the permeation barrier is a spray-on barrier.

10. The composite pressure vessel of claim 1 wherein the permeation barrier is selected from the group consisting of elastomers.

11. A mandrel for a composite pressure vessel, comprising:
a center portion and at least two end portions, wherein the mandrel forms an integral part of the pressure vessel.

12. The mandrel of claim 11 wherein the body is comprised of a material selected from the group consisting of metals, copper, nickel, aluminum, nonconductors, silicon, carbon, high density polyethylene, polymers, plastics, fiber reinforcements, glass, carbon, nylon, polyester, boron, basalt, ceramic and combinations thereof.

13. The mandrel of claim 11 wherein the ends form domes.

14. The composite pressure vessel of claim 13 wherein the ends are comprised of glass fiber or cloth weave with vinyl ester or polyester resin.

15. The mandrel of claim 11 wherein the domes further comprise a flange for securing the ends to the body of the mandrel.

16. The mandrel of claim 11 wherein the ends form openings that are gasketed with fittings.

17. The mandrel of claim 11 further comprising a permeation barrier.

18. The mandrel of claim 17 wherein the permeation barrier is an elastomer.

19. A method of making a composite pressure vessel, the method comprising the steps of:
forming an integrated mandrel from multiple components;
creating a permeation barrier inside the mandrel; and
including the integrated mandrel as part of the pressure vessel.

20. The method of claim 19 wherein the step of forming an integrated mandrel further comprises the step of forming a cylinder and at least two ends, the cylinder having a diameter, an interior and an exterior.

21. The method of claim 20 wherein each end further comprises a flange that is either smaller or larger in diameter than the cylinder and wherein the method further comprises the steps of securing the flanges to either the interior or exterior of the cylinder.

22. The method of claim 20 further comprising the step of joining the cylinder and ends with a joining resin.

23. The method of claim 22 wherein the joining resin is selected from the group consisting of methacrylate adhesives.

24. The method of claim 19 further comprising the step of overwrapping the mandrel with composite fiber.

25. The method of claim 20 further comprising the step of supplying port fittings in the ends.

26. The method of claim 20 wherein the step of creating a permeation barrier further comprises the step of spraying an elastomer inside the mandrel.
